(19) United States
(12) Patent Application Publication
(10) Pub. No.: US 2009/0235126 A1
(43) Pub. Date: Sep. 17, 2009

(54) Batch processing apparatus and method

(75) Inventor: Masaaki Hosouchi, Zama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/081,563

(22) Filed: Apr. 17, 2008

(30) Foreign Application Priority Data
Mar. 11, 2008 (JP) 2008-061060

(51) Int. Cl. G06F 11/07

(52) U.S. Cl. 714/57; 714/E11.025

(57) ABSTRACT

Proposed are a batch processing apparatus and a batch processing method capable of realizing laborsaving in a batch job operation when a failure occurs. In a batch processing apparatus and method for executing batch processing using a prescribed resource, the resource to be used by a job to be executed subsequently in the batch processing is identified and whether a failure has occurred in the resource is determined, and failure information concerning the failure is presented to a user and the execution of the job is postponed until a reply is received from the user when it is determined that a failure has occurred in the resource.

### CROSS-REFERENCES

This application relates to and claims priority from Japanese Patent Application No. 2008-61060, filed on Mar. 11, 2008, the entire disclosure of which is incorporated herein by reference.

### BACKGROUND

The present invention generally relates to a batch processing apparatus and a batch processing method and, for instance, can be suitably applied to a computer that executes batch processing using a resource in a storage device.

A batch processing system for interpreting and executing job definition files describing the file to be used (input/output) by an application program in a job, which is the unit of batch processing, in a batch processing system for compiling data for a given period of time or in a given quantity and collectively performing processing is disclosed, for example, in Japanese Patent Laid-Open Publication No. 2007-41720. In addition, Japanese Patent Laid-Open Publication No. 2005-222105 discloses technology for collectively resuming the operation of a plurality of jobs, which failed due to the same failure factor, when such plurality of jobs are recovered from that failure factor.

In a conventional batch processing system, a pre-scheduled job is executed even when a failure occurs in a logical volume (hereinafter simply referred to as a “volume”) in a storage device storing the file to be used in the job, or in a path (communication path) between the volume and a computer in which an application program is operating.

Nevertheless, when the job is to use the file stored in the logical volume subject to a failure, that job will abend. Thus, the user is required to determine whether the abend factor is a failure in the volume or the path based on the job output result or the failure log, and re-schedule the job after the volume or path is recovered from the failure.

### SUMMARY

With the conventional batch processing system described above, the prescheduled job is executed even when a failure occurs, and the job will abend at the point in time the job tries to use the file stored in the failed volume. Thus, the user is required to identify the abend factor each time, perform processing for restoring the abnormal location and thereafter reschedule the job, and there is a problem in that the user is compelled to perform extra tasks.

The present invention was made in view of the foregoing points. Thus, an object of this invention is to propose a batch processing apparatus and method capable of realizing laborsaving in a batch job operation when a failure occurs.

In order to achieve the foregoing object, the present invention identifies the resource to be used by a job to be executed subsequently in the batch processing and determines whether a failure has occurred in the resource, and, when it is determined that a failure has occurred in the resource, presents failure information concerning the failure to a user and postpones the execution of the job until a reply is received from the user.

Specifically, the present invention provides a batch processing apparatus comprising a main memory storing a program, and a processor for executing batch processing using a prescribed resource according to the program stored in the main memory. The processor identifies the resource to be used by a job to be executed subsequently in the batch processing and determines whether a failure has occurred in the resource, and, when the processor determines that a failure has occurred in the resource, the processor presents failure information concerning the failure to a user and postpones the execution of the job until it receives a reply from the user.

The present invention additionally provides a batch processing method for executing batch processing using a prescribed resource. This batch processing method comprises a first step for identifying the resource to be used by a job to be executed subsequently in the batch processing and determining whether a failure has occurred in the resource, and a second step for presenting failure information concerning the failure to a user and postponing the execution of the job until a reply is received from the user when it is determined that a failure has occurred in the resource.

The present invention further provides a program for causing a computer to execute processing comprising a first step for identifying, in batch processing using a prescribed resource, the resource to be used by a job to be executed subsequently in the batch processing and determining whether a failure has occurred in the resource, and a second step for presenting failure information concerning the failure to a user and postponing the execution of the job until a reply is received from the user when it is determined that a failure has occurred in the resource.

According to the present invention, since failure information of a resource to be used by the scheduled job is presented to the user and such user is requested to provide a reply, it is possible to confirm the occurrence of a failure by narrowing down the potential failure locations to a point in time before the job was executed based on the foregoing information, and laborsaving can be realized in the batch job operation when a failure occurs in a storage.

### DESCRIPTION OF DRAWINGS

FIG. 1 is a block diagram showing the overall configuration of a computer system according to an embodiment of the present invention;

FIG. 2A and FIG. 2B are conceptual diagrams showing a descriptive example of a job definition file;

FIG. 3 is a conceptual diagram showing a configuration example of a job file management table;

FIG. 4 is a conceptual diagram showing a configuration example of a job volume management table;

FIG. 5 is a conceptual diagram showing a configuration example of a volume pair management table;

FIG. 6 is a conceptual diagram showing a configuration example of a volume management table;

FIG. 7 is a conceptual diagram showing a configuration example of a volume path management table;

FIG. 8 is a conceptual diagram showing a configuration example of a path management table;

FIG. 9 is a flowchart showing the processing routine of the job execution processing;

FIG. 10 is a schematic diagram showing a display example of a failure notification screen;

FIG. 11 is a flowchart showing the processing routine of the volume failure check processing;

FIG. 12 is a schematic diagram showing a display example of a failure notification screen; and

FIG. 13 is a flowchart showing the processing routine of the failure replication information send processing.

### DETAILED DESCRIPTION

An embodiment of the present invention is now explained in detail with reference to the attached drawings.

### (1) Configuration of Computer System in Present Embodiment

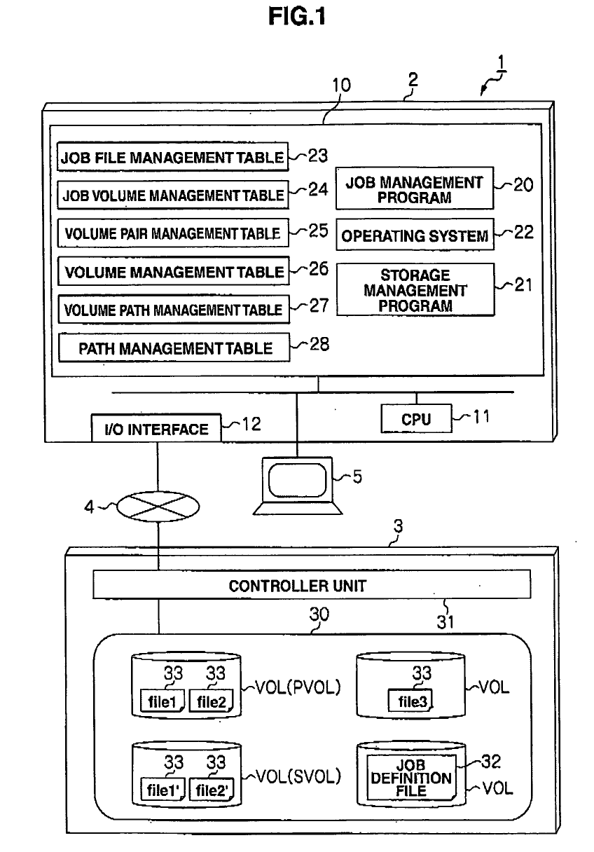

FIG. 1 shows the overall computer system 1 according to the present embodiment. The computer system 1 comprises a computer 2 for executing batch processing, and a storage device 3 for providing a storage area to the computer 2. The computer 2 and the storage device 3 are connected via a communication network 4 such as a SAN (Storage Area Network), a LAN (Local Area Network), a WAN (Wide Area Network), Internet, a dedicated line or a public line.

The computer 2 comprises a main memory 10, a CPU (Central Processing Unit) 11, and an I/O interface 12. The main memory 10 is configured from a semiconductor memory or the like. The main memory 10 stores operation codes of a job management program 20, a storage management program 21, and an operating system 22, and various tables 23 to 28 to be referred to by the job management program 20, the storage management program 21, and the operating system 22.

The CPU 11 is a processor for governing the operational control of the overall computer 2, and loads, interprets and executes the operation codes of the job management program 20, the storage management program 21 and the operating system 22 stored in the main memory 10. Although the processing entity of the various types of processing is explained as a “program” in the ensuing explanation, it goes without saying that in reality the CPU 11 executes the processing based on the program.

The I/O interface 12 is an interface for accessing the storage device 3 via the communication network 4.

Connected to the computer 2 is a console 5 for displaying a message from a program in the computer 2, accepting a reply from the user in response to the message, and transferring such reply to the computer 2. The console 5 is configured from a personal computer or the like.

The storage device 3 is configured from a storage unit 30 and a controller unit 31. The storage unit 30 comprises one or more disk drives for respectively providing a physical storage area. One or more logical volumes VOL are defined in the storage area provided by the one or more disk drives. Job definition files 32 created by the user and files 33 to be used by the application program in the computer 2 are stored in these volumes VOL. The controller unit 31 performs the input and output of the job definition files 32 and the files 33 to be used by the programs to and from the storage unit 30 according to an I/O request from the computer 2.

In the case of the computer system 1, by using the replication function loaded in the computer 2 or the storage device 3, a replication of the volume VOL to be used by the computer 2 for reading and writing the files 32 can be created in the storage device 3. Here, the update contents of a replication source volume VOL are differentially reflected synchronously or asynchronously in a replication destination volume VOL, and the contents of the replication source volume VOL and the contents of the replication destination volume VOL are constantly maintained in the same status. In the ensuing explanation, the replication source volume VOL is referred to as a primary volume PVOL, the replication destination volume VOL is referred to as a secondary volume SVOL, and a pair configured from the primary volume PVOL and the secondary volume SVOL is referred to as a volume pair.

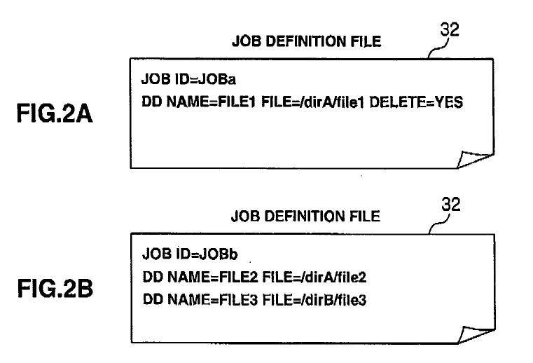

FIG. 2 shows a descriptive example of a job definition file 32. The job definition file 32 is a file defining the content of the job to be executed by the application program in the computer 2 and, for instance, is created in advance by a user using the computer 2, and stored in a prescribed volume VOL in the storage device 3.

In FIG. 2, the top row shows the job definition text. “JOBa” that follows “JOB ID=” shows the job ID uniquely identifying the job. The second row shows the file definition text of the file 33 to be used by the application program that will execute the job. “FILE 1” following “DD NAME=” shows the file identification name for identifying the file 33, and “/dirA/file1” following “FILE=” shows the path name of the file 33. “DELETE=YES” in the file definition text shows that the file 33 will be deleted after the job is completed. Although not shown in FIG. 2, the job definition file 32 also describes identifying information and the like of the application program in the computer to execute the job.

### (2) Batch Processing Function of Computer

The failure processing function loaded in the computer 2 of the computer system 1 is now explained. The computer 2 of this embodiment is loaded with a batch processing function of sequentially and consecutively executing jobs defined in a plurality of job definition files 32 according to the respective job definition files 32 stored in a prescribed volume VOL of the storage device 3.

Here, one feature of the computer 2 is that it checks whether a failure has occurred or may occur in the volume VOL to be used by a job or in the path between the volume VOL and the computer 2 before executing that job during batch processing and, when a failure has occurred or may occur, postpones the execution of the job until it receives permission from the user.

As means for executing this type of batch processing, the main memory 10 of the computer 2 stores a job file management table 23, a job volume management table 24, a volume pair management table 25, a volume management table 26, a volume path management table 27, and a path management table 28.

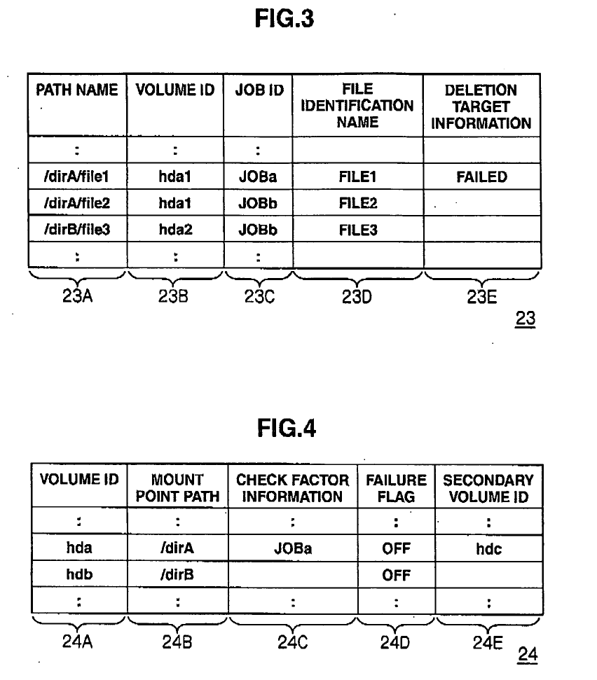

The job file management table 23 is a table for the job management program 20 to manage the jobs defined in the job definition file 32, and, as shown in FIG. 3, is configured from a path name column 23A, a volume ID column 23B, a job ID column 23C, a file identification name column 23D, and a deletion target information column 23E.

The job ID column 23C stores an identifier (hereinafter referred to as a “job ID”) of the job defined in the job definition file 32, and the file identification name column 23D stores an identifier (hereinafter referred to as a “file identification name”) of the file 33 to be used in that job.

The path name column 23A stores a path name of the path from the computer 2 to the file 33, and the volume ID column 23B stores an identifier (hereinafter referred to as a “volume ID”) of the volume VOL in the storage device 3 storing the file 33. As the volume ID, for instance, a device name such as “hda” or a device ID of a four-digit, hexadecimal number is used.

The deletion target information column 23E stores information (hereinafter referred to as the “deletion target information”) for determining whether to delete the file 33 used in the job after the corresponding job is complete. For example, if there is a description of “DELETE=YES” in the file definition text, the deletion target information of “YES” is stored in the deletion target information column 23E. The deletion target information of “FAILED” is stored in the deletion target information column 23E if the file 33 could not be deleted after the completion of the corresponding job due to a factor such as an abnormal volume. In all other cases, the deletion target information is not stored in the deletion target information column 23E.

The job volume management table 24 is a table for the job management program 20 to manage the volume VOL to be used by the jobs to be batch-processed, and, as shown in FIG. 4, is configured from a volume ID column 24A, a mount point path column 24B, a check factor information column 24C, a failure flag column 24D, and a secondary volume column 24E.

The volume ID column 24A stores a volume ID of each volume VOL in which the volume ID is registered in the job file management table 23. The mount point path column 24B stores a path name of a directory (mount point) on which the corresponding volume VOL is mounted. The character string that links the path name in the volume VOL to the path name stored in the mount point path column 24B becomes the path name of the file 33.

The check factor information column 24C stores a job ID of a job when that job using the corresponding volume VOL abends. The failure flag column 24D stores a flag (hereinafter referred to as a “failure flag”) showing whether a failure has occurred in the corresponding volume VOL. As described later, if a job ID is stored in the check factor information column 24C, whether a failure has occurred in the corresponding volume VOL is checked, and, if it is detected that a failure has occurred in the volume VOL as a result of this check, the failure flag is turned “ON.” If the failure flag is “OFF,” this shows a status where a failure has not occurred in the corresponding volume VOL, or whether a failure has occurred in the volume VOL has not been checked.

If there is a secondary volume SVOL (replication) of the corresponding volume VOL, the secondary volume ID column 24E additionally stores the volume ID of the secondary volume SVOL. Thus, if a secondary volume SVOL of the corresponding volume VOL does not exist, nothing is stored in the secondary volume ID column 24E of that entry.

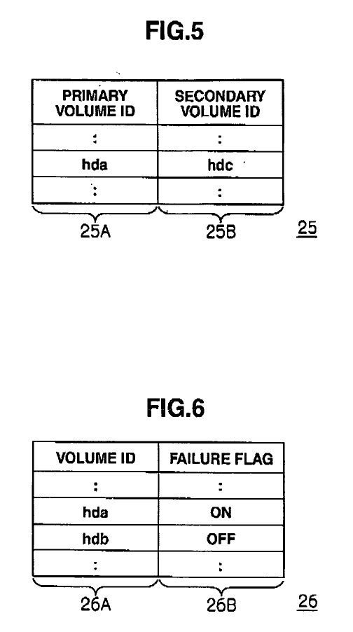

Meanwhile, the volume pair management table 25 is a table for the storage management program 21 to manage the volume pairs in the storage device 3, and, as shown in FIG. 5, is configured from a primary volume ID column 25A and a secondary volume ID column 25B. The primary volume ID column 25A and the secondary volume ID column 25B respectively store the volume ID of the primary volume PVOL or the secondary volume SVOL of each volume pair configured in the storage device 3.

The volume management table 26 is a table for the storage management program 21 to manage the failure of a volume VOL, and, as shown in FIG. 6, is configured from a volume ID column 26A and a failure flag column 268. The volume ID column 26A stores the volume ID of each volume VOL set in the storage device 3, and the failure flag column 26B stores a volume failure flag showing whether a failure has occurred in the corresponding volume VOL. Here, the volume failure flag set to “ON” if a failure has occurred in the corresponding volume VOL, and set to “OFF” if a failure has not occurred in the volume VOL.

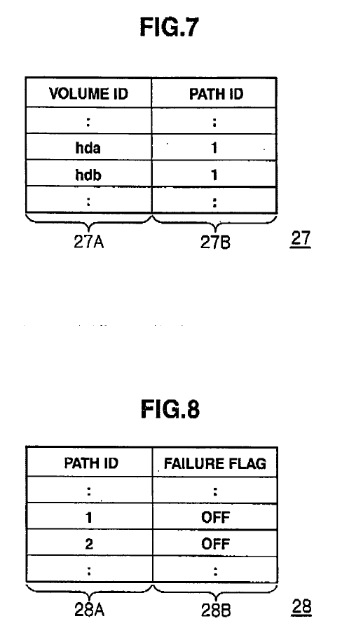

The volume path management table 27 is a table for the storage management program 21 to manage the path from the computer 2 to each volume VOL, and, as shown in FIG. 7, is configured from a volume ID column 27A and a path ID column 27B. The volume ID column 27A stores the volume ID of the corresponding volume VOL, and the path ID column 27B stores the path ID of the path to that volume VOL. The path ID is created by combining, for example, the identifier of the I/O interface 12 (FIG. 1) of the computer 2 and the identifier of the reception port of the storage device 3.

The path management table 28 is a table for the storage management program 21 to manage the path failure between the computer 2 and the volume VOL, and, as shown in FIG. 8, is configured from a path ID column 28A and a failure flag column 28B. The path ID column 28A stores the path ID of the corresponding path, and the failure flag column 28B stores the path failure flag showing whether a failure has occurred in that path. The path failure flag is set to “ON” if a failure has occurred in the corresponding path and set to “OFF” if a failure has not occurred in the corresponding path.

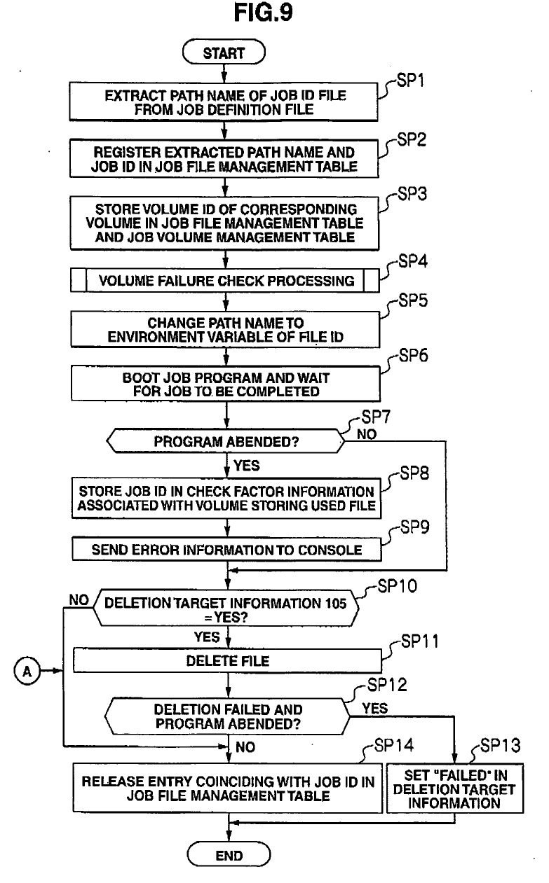

FIG. 9 shows the processing routine of the job execution processing based on the job management program 20. The job management program 20, during the batch processing, foremost reads the job definition file 32 of the job to be executed subsequently from the storage device 3. The job management program 20 analyzes the read job definition file 32, and respectively extracts the job ID from the ID operand of the job definition text, the environment variable name from the NAME operand, the path name of the file 33 from the FILE operand, and whether to delete the file 33 from the DELETE operand. If a plurality of job definition texts exist in the job definition file 32, similar processing is performed regarding each job definition text (SP1).

Subsequently, the job management program 20 allocates one new entry of the job file management table 23 to one job definition text of that job definition file 32, and respectively stores the path name, the job ID, and the file ID concerning the job definition text extracted from that job definition file 32 at step SP1 in the path name column 23A, the job ID column 23C, and the file identification name column 23D of that new entry. The job management program 20 stores the deletion target information of “YES” in the deletion target information column 23E of that new entry if a DELETE operand exists in that job definition text (SP2).

Subsequently, the job management program 20 seeks the volume ID of the volume VOL storing the file 33 to be used in that job, and stores that volume ID in the job file management table 23 and, as necessary, in the job volume management table 24 (SP3).

Specifically, the job management program 20 issues a stat( ) function, and makes an inquiry regarding the device ID (volume ID) corresponding to the path name stored in the path name column 23A of the new entry allocated to that job in the job file management table 23, or reads the file (fstab) describing the file system information of the volume VOL to be mounted. The job management program 20 stores the volume ID obtained as described above in the volume ID column 23B of the new entry of the job file management table 23.

If the acquired volume ID is not registered in the job volume management table 24, the job management program 20 allocates one new entry of the job volume management table 24 to the volume VOL of that volume ID, stores the volume ID in the volume ID column 24A of that entry, and stores the path name up to the mount point on which the volume VOL of that volume ID is mounted in the mount point path column 24B of the new entry.

If a plurality of job definition texts are described in the target job definition file 32, the job management program 20 executes the processing of step SP2 and step SP3 for each job definition text.

Subsequently, the job management program 20 executes the volume failure check processing for checking whether a failure has occurred in the volume VOL to be used in the job defined in the job definition file 32 (that is, the volume VOL storing the file 33 to be used in the job) or the path between the volume VOL and the computer 2 (SP4). The specific processing contents of this volume failure check processing will be described later.

The job management program 20 thereafter changes the path name stored in the path name column 23A to a file identification name (environment variable) stored in the file identification name column 23D regarding all entries in which the job ID of the jobs defined in the job definition file 32 is stored in the job 10 column 23C among the entries of the job file management table 23 (SP5).

Subsequently, the job management program 20 refers to the job definition file 32 and boots the application program to execute the job, and waits for the job to end (SP6). When the job eventually ends, the job management program 20 determines whether the job abended (SP7). The job management program 20 proceeds to step SP10 upon obtaining a negative result in this determination.

Contrarily, if the job management program 20 obtains a positive result in this determination, since either a volume failure or a path failure can be considered as the factor that caused the job to be abended, it is necessary to check the volume VOL to be used by that job and the path to the volume VOL before executing the subsequent job.

Thus, the job management program 20 reads the volume ID of the volume VOL used by the abended job from the job file management table 23, and stores the job ID of the abended job in the check factor information column 24C of the entries in which that volume ID is stored in the volume ID column 24A among the entries of the job volume management table 24 (SP8).

The job management program 20 additionally sends the job ID of the abended job or the volume ID of the volume VOL used in the job as failure information to the console 5 (FIG. 1) (SP9). Consequently, the console 5 displays a prescribed failure notification screen based on the failure information and urges the user to check the failure.

If there is a setting (“DELETE=YES”) for deleting the file 33 used in the executed job, the job management program 20 deletes the file 33 (SP10, SP11). Specifically, the job management program 20 determines whether there is an entry in which the job ID of the executed job is stored in the job ID column 23C and “YES” is stored in the deletion target information column 23E among the entries of the job file management table 23 (SP10). If the job management program 20 obtains a negative result in this determination, it proceeds to step SP14. Contrarily, if the job management program 20 obtains a positive result in this determination, it deletes the corresponding file 33 from the volume VOL used in that job (SP11).

The job management program 20 thereafter determines whether the executed job has abended, and whether the deletion processing of the file 33 at step SP11 also ended in a failure (SP12). If the job management program 20 obtains a positive result in this determination, in order to delete the file 33 after the recovery of the volume failure, it changes the deletion target information stored in the deletion target information column 23E of the corresponding entry of the job file management table 23 to “FAILED” (SP13).

Meanwhile, if the job management program 20 obtains a negative result in the determination at step SP12, since the entry of the job file management table 23 is no longer required, it releases (deletes from the job file management table 23) all entries in which the job ID stored in the job ID column 23C coincides with the job ID of the job executed at step SP6 and in which the deletion target information of “FAILED” is not stored in the deletion target information column 23E among the entries of the job file management table 23 (SP14).

The job management program 20 thereafter ends the job execution processing concerning the target job definition file 32, and, when there are other job definition files 32, it repeats the same processing (SP1 to SP14) regarding all job definition files 32.

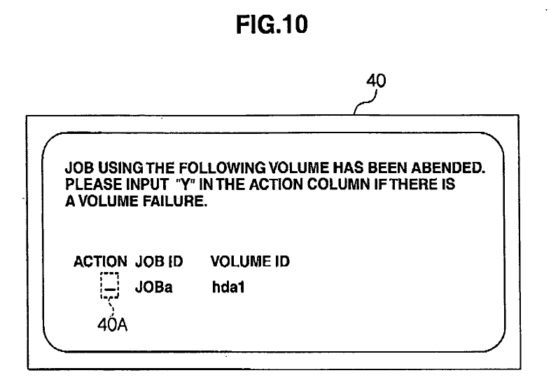

FIG. 10 shows a configuration example of the failure notification screen displayed by the console 5 based on the failure information received from the job management program 20 at step SP9 of the job execution processing. The failure notification screen 40 shown in FIG. 10 displays a message to the effect that the job has abended, the job ID of the abended job, and the volume ID of the volume VOL used in the job. The user checks whether a failure has occurred in the volume VOL (“hda1” in FIG. 10) in which the volume ID is displayed in the failure notification screen 40, and inputs “Y” in the ACTION column 40A when it is acknowledged that a failure has occurred, and inputs “N” in the ACTION column 40A when it is acknowledged that a failure has not occurred. If “Y” is input in the ACTION column 40A, this is notified to the job management program 20 of the computer 2.

The job management program 20 that received this notice may also turn “ON” the failure flag stored in the failure flag column 24D of the corresponding entry of the job volume management table 24 (entry in which the volume ID described in the row where “Y” was input in the ACTION column 40A is stored in the volume ID column 24A), and erase the job ID stored in the check factor information column 24C of that entry.

Instead of making input in the failure notification screen 40, the user may input a command designating the volume ID of the failed volume VOL as the operand, and the job management program 20 may turn “ON” the failure flag stored in the failure flag column 24D of the corresponding entry of the job volume management table 24 based on the foregoing command.

Moreover, the job management program 26 may monitor the storage failure message output from the operating system 22 (FIG. 1), and turn “ON” the failure flag of the failure flag column 24D of the entry in which the volume ID contained in the storage failure message is stored in the volume ID column 24A among the entries of the job volume management table 24.

In addition, the storage management program 21 may notify the volume ID of the failed volume VOL to the job management program 20, and the job management program 20 that received this notice may turn “ON” the failure flag of the failure flag column 24D of the entry in which the notified volume ID is stored in the volume ID column 24A among the entries of the job volume management table 24.

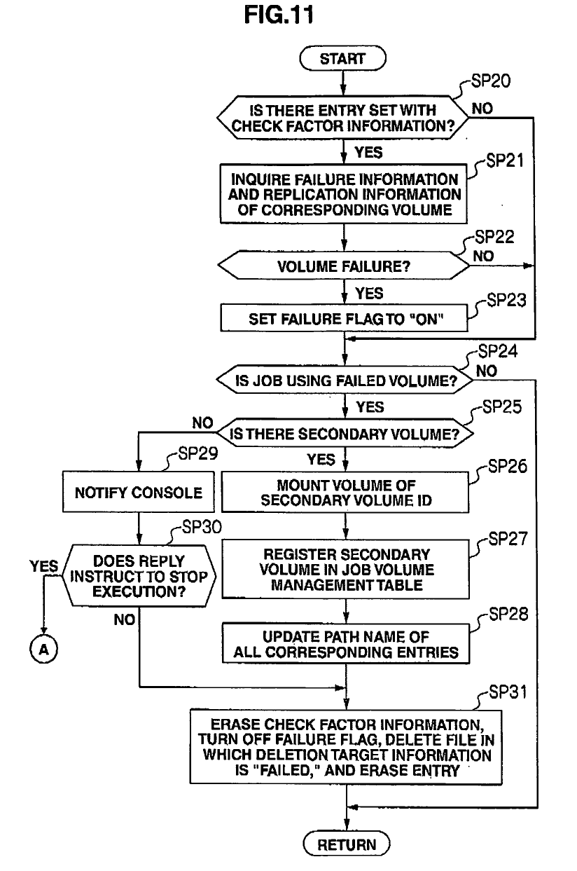

FIG. 11 shows the specific processing contents of the volume failure check processing to be executed by the job management program 20 at step SP4 of the job execution processing described with reference to FIG. 9.

When the job management program 20 proceeds to step SP9 of the job execution processing, it starts the volume failure check processing, and foremost verifies the existence of a failure regarding a volume VOL which may be subject to a failure such as the volume VOL that was used in the abended job (SP20 to SP23).

Specifically, the job management program 20 checks each entry of the job volume management table 24, and determines whether there is an entry in which the check factor information (job ID of corresponding job) is set in the check factor information column 24C (SP20).

If the job management program 20 obtains a negative result in this determination, it proceeds to step SP24. Meanwhile, if the job management program 20 obtains a positive result in this determination, it designates the volume ID and requests the storage management program 21 (FIG. 1) to send the failure information on whether a failure has occurred in the volume VOL of the volume ID stored in the volume ID column 24A and the replication information on whether a secondary volume SVOL exists in that volume VOL regarding each entry in which the check factor information is stored in the check factor information column 24C (SP21).

Instead of step SP21, the job management program 20 may confirm the existence of a failure by accessing the directory showing the path name stored in the mount point path column 24B of the corresponding entry of the job volume management table 24, or the file 33 under its control. The job management program 20 may also obtain the failure information of the corresponding volume VOL by sending the volume ID stored in the volume ID column 24A of the corresponding entry of the job volume management table 24 to the operating system 22. Further, the job management program 20 may perform the processing of step SP21 to all volumes used by the job to be executed instead of performing step SP20.

The job management program 20 determines whether a failure has occurred in the volume VOL based on the failure information of the volume VOL sent from the storage management program 21 according to the request at step SP21 (SP22). If the job management program 20 obtains a negative result in this determination, it proceeds to step SP24. Contrarily, if the job management program 20 obtains a positive result in this determination, it turns “ON” the failure flag stored in the failure flag column 24D of the corresponding entry of the job volume management table 24 (SP23).

Instead of performing the processing of step SP20 to step SP23, the job management program 20 may end this volume failure check processing if there is no entry in the job volume management table 24 in which the failure flag stored in the failure flag column 24D is set to “ON” and there is no entry in which the check factor information is stored in the check factor information column 24C at step SP24. Here, since the user is requested to provide a reply if there is a volume VOL that may be subject to a failure, the user will determine the existence of a failure on behalf of the storage management program 21.

The job management program 20 thereafter determines whether a failure has occurred in the volume VOL to be used in the job to be executed subsequently (SP24). Specifically, the job management program 20 detects all entries in which the job ID stored in the job ID column 23C coincides with the job ID of the job defined in the target job definition file 32 among the entries of the job file management table 23, and detects the volume IDs respectively stored in the volume ID column 23B of those entries. The job management program 20 determines whether there is an entry among such entries of the job volume management table 24 in which the detected volume ID is stored in the volume ID column 24A and the failure flag stored in the failure flag is set to “ON.”

To obtain a negative result in this determination means that a failure has not occurred in the volume VOL to be used by the job defined in the target job definition file 32. Consequently, the job management program 20 in this case ends this volume failure check processing and returns to the job execution processing explained with reference to FIG. 9.

Meanwhile, to obtain a positive result in this determination means that a failure has occurred in the volume VOL to be used by the job defined in the target job definition file 32. Consequently, the job management program 20 in this case determines whether a secondary volume SVOL exists in the volume VOL based on the replication information sent from the storage management program 21 according to the request at step SP21 (SP25).

If the job management program 20 obtains a positive result in this determination, it switches the volume VOL to be used in the job to the secondary volume SVOL of that volume VOL (SP26 to SP28).

Specifically, the job management program 20 mounts the secondary volume SVOL detected at step SP25 (SP26). The job management program 20 registers the secondary volume SVOL in the job volume management table 24 (SP27). More specifically, the job management program 20 allocates a new entry to the job volume management table 24, stores the volume ID of the secondary volume SVOL in the volume ID column 24A of that new entry, and stores the path name of the directory of the mount destination of the secondary volume SVOL in the mount point path column 24B of that new entry.

The job management program 20 replaces the top portion that coincides with the path of the mount destination of the corresponding secondary volume SVOL among the path names stored in the path name column 23A with the mount point path of the secondary volume SVOL regarding all entries in which the volume ID of the primary volume of the secondary volume SVOL (that is, the volume VOL that was originally scheduled to be used in the job) registered in the job volume management table 24 at step SP26 among the entries of the job file management table 23 (SP28).

Subsequently, the job management program 20 erases the file 33 to be erased that is still remaining in the failed volume VOL, and erases the file 33 corresponding to the entry in which the deletion target information of “FAILED” is stored in the deletion target information column 23E of the job file management table 23 (FIG. 3) (SP31).

Specifically, the job management program 20 erases the check factor information stored in the check factor information column 24C of the entry corresponding to the volume VOL switched to the secondary volume SVOL at step SP26 to step SP28 among the entries of the job volume management table 24, and turns “OFF” the failure flag stored in the failure flag column 24D of the entry. If there is an entry in which the volume ID of the failed volume VOL is stored in the volume ID column 23B and “YES” is stored in the deletion target information column 23E among the entries of the job file management table 23, the job management program 20 deletes the file 33 showing the path name stored in the path name column 23A of that entry from the failed volume VOL. The job management program 20 thereafter deletes that entry from the job file management table 23. In addition to the foregoing processing, the job management program 20 erases the entry in which the deletion target information of “FAILED” is stored in the deletion target information column 23E of the job file management table 23, and deletes the file corresponding to the entry from the volume VOL. The job management program 20 thereafter returns to the job execution processing explained with reference to FIG. 9.

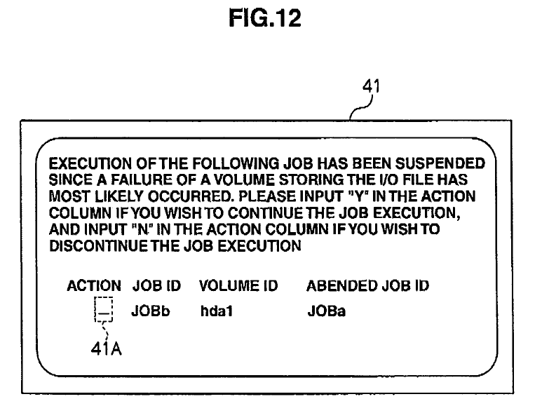

Meanwhile, if the job management program 20 obtains a negative result in the determination at step SP25, it notifies the console 5 (FIG. 1) of the failure information including the job ID of the job defined in the target job definition file 32, the volume ID of the volume VOL to be used in the job defined in the job definition file 32, and the job name of the abended job stored in the check factor information column 24C of the entry corresponding to the volume VOL of the job volume management table 24 (SP29). “The console 5 consequently displays, based on this failure information, a failure notification screen 41 as shown in FIG. 12 displaying a message to the effect that the execution of the job has been suspended since there is a possibility that a failure has occurred in the volume VOL to be used in the job to be executed subsequently, the job ID of the job in which the execution was suspended, the volume ID of the volume VOL to be used in that job, and the job ID of the job that was abended as a result of using that volume VOL. The user is able to select whether to execute or stop the job by inputting “Y,” which means to execute the target job, or “N,” which means to stop the execution of the job, in the ACTION column 41A of the failure notification screen 41.

Nevertheless, upon selecting the option of “execute the job,” it is necessary to perform the recovery operation (for instance, replacement of the corresponding disk drive) in order to recover the failed volume VOL from the failure. This is because if the recovery operation is not performed, this job will also be abended.

If “Y” or “N” is input to the ACTION column 41A of the failure information screen 41, the console 5 notifies whether “Y” or “N” was selected to the job management program 20.

When the job management program 20 receives this notice, it determines whether to stop the target job based on the notice (SP30). If the job management program 20 obtains a positive result in this determination, it returns to the job execution processing explained with reference to FIG. 9 and proceeds to step SP14 of the job execution processing.

Meanwhile, if the job management program 20 obtains a negative result in this determination, it executes the processing of step SP31 as described above, and thereafter returns to the job execution processing.

In the volume failure check processing explained above, instead of the job management program 20 acquiring the replication information from the storage management program 21 at step SP21 and mounting the secondary volume SVOL at step SP26, the user may mount the secondary volume SVOL, notify the path name of the mount point path of the primary volume PVOL (that is, the volume VOL subject to a failure before switching to the secondary volume SVOL) and the path name of the mount point path of the secondary volume SVOL to the job management program 20 using a command, and perform the processing at step SP27 in advance.

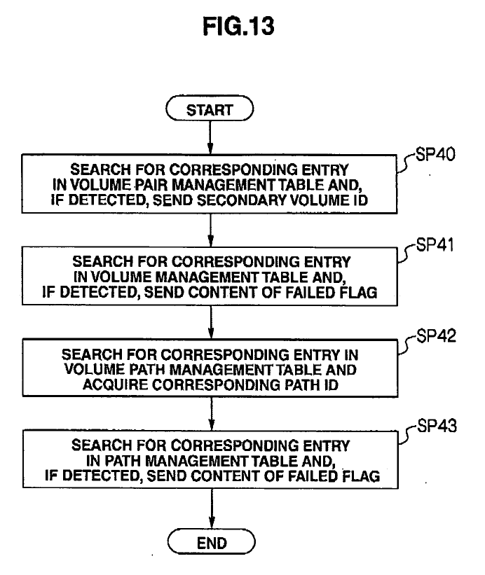

The processing contents of the failure replication information send processing to be executed by the storage management program 21 that received the send request of the failure information and the replication information of the volume VOL from the job management program 20 at step SP21 of the volume failure check processing (FIG. 11) are now explained with reference to FIG. 13.

When the storage management program 21 receives a request from the job management program 20 to send the failure information and the replication information of the volume VOL, it starts this failure replication information send processing, and foremost searches for an entry in which the volume ID of the target volume VOL and the volume ID stored in the primary volume ID column 25A coincide from the volume pair management table 25. When the storage management program 21 detects an entry in which the volume IDs coincide as a result of the search, it sends the volume ID of the secondary volume SVOL of that entry to the job management program 20 (SP40). The storage management program 21 acquires the volume ID of the primary volume PVOL and the volume ID of the secondary volume SVOL of each volume pair configured beforehand in the storage device 3 from the storage device 3, and creates the volume pair management table 25 based on the acquired information.

Subsequently, the storage management program 21 searches for an entry in which the volume ID of the inquiry-target volume VOL and the volume ID stored in the volume ID column 26A coincide from the volume management table 26. If the storage management program 21 detects an entry in which the volume IDs coincide as a result of the search, it sends the content (“ON” or “OFF”) of the volume failure flag stored in the failure flag column 26B of that entry to the job management program 20 (SP41). The storage management program 21 makes an inquiry to the storage device 3 or the operating system 22 (FIG. 1) of the computer 2 regarding the existence of a volume failure before step SP41 or in given intervals, and updates the corresponding volume failure flag of the volume management table 26 based on the obtained volume failure information as needed.

Subsequently, the storage management program 21 searches for an entry in which the volume of the inquiry-target volume VOL and the volume ID stored in the volume ID column 27A coincide from the volume path management table 27. If the storage management program 21 detects an entry in which the volume IDs coincide as a result of the search, it acquires the path ID of the corresponding path stored in the path ID column 27B of that entry (SP42).

The storage management program 21 searches for an entry in which the path ID obtained as described above and the path ID stored in the path ID column 28A coincide from the path management table 28, and sends the content (“ON”or “OFF”) of the path failure flag stored in the path failure flag column 28B of the entry detected in the search to the job management program 20 (SP43). The storage management program 21 thereafter ends this failure replication information send processing. The storage management program 21 makes an inquiry to the storage device 3 or the operating system 22 of the computer 2 regarding the existence of a failure in the path (communication path) identified by each path ID before step SP41 or in given intervals, and updates the path failure flag column 28B of the path management table 28 based on the obtained path failure information as needed.

### (3) Effect of Present Embodiment

As described above, with the computer system 1 of the present embodiment, during the batch processing, since whether a failure has or may occur in the volume to be used in the job or in the path between the volume VOL and the computer 2 is checked before executing the job, and when a failure has or may occur, this is notified to the user and the execution of the subsequent jobs is postponed until a permission is obtained from the user, the user is able to easily identify the abend factor of the abended job. Thus, even if a job is abended, it is possible to omit the task of the user identifying the abend factor and re-scheduling the job, and consequently possible to realize a computer system capable of realizing laborsaving in a batch job operation.

### (4) Other Embodiments

Although the foregoing embodiment explained a case of applying the present invention to the computer 2 of the computer system 1 configured as illustrated in FIG. 1, the present invention is not limited thereto, and may also be broadly applied to various types of information processing apparatuses capable of performing batch processing.

Further, although the foregoing embodiment explained a case of checking the occurrence of a failure in the volume VOL to be used in the job and the path between the computer 2 and the volume VOL before executing the job to be executed subsequently in the batch processing, the present invention is not limited thereto, and the occurrence of a failure in the other resources to be used by the subsequent job other than the volume VOL and the path may also be checked.

Moreover, although the foregoing embodiment explained a case where the failure notification screens 40, 41 are configured as illustrated in FIG. 10 and FIG. 12, the present invention is not limited thereto, and may be broadly applied to other various configurations.

The present invention can be broadly applied to various types of information processing apparatuses loaded with a batch processing function.

What is claimed is:

1. A batch processing apparatus, comprising:
a main memory storing a program; and
a processor for executing batch processing using a prescribed resource according to the program stored in the main memory;
wherein the processor identifies the resource to be used by a job to be executed subsequently in the batch processing and determines whether a failure has occurred in the resource, and, when the processor determines that a failure has occurred in the resource, the processor presents failure information concerning the failure to a user and postpones the execution of the job until it receives a reply from the user.

2. The batch processing apparatus according to claim 1,
wherein the resource is a logical volume provided in a storage device.

3. The batch processing apparatus according to claim 1,
wherein the resource additionally includes a path up to the volume.

4. The batch processing apparatus according to claim 1,
wherein the processor determines whether a failure has occurred in the resource to be used by the job to be executed subsequently based on whether the resource to be used by the job to be executed subsequently is a resource that was used by an abended job among the previously executed jobs in the batch processing.

5. The batch processing apparatus according to claim 2,
wherein, if there is a replication of the logical volume in which a failure has occurred, the job is executed by switching the logical volume to be used by the job to the replication without postponing the execution of the job.

6. A batch processing method for executing batch processing using a prescribed resource, comprising:
a first step for identifying the resource to be used by a job to be executed subsequently in the batch processing and determining whether a failure has occurred in the resource; and
a second step for presenting failure information concerning the failure to a user and postponing the execution of the job until a reply is received from the user when it is determined that a failure has occurred in the resource.

7. The batch processing method according to claim 6,
wherein the resource is a logical volume provided in a storage device.

8. The batch processing method according to claim 7,
wherein the resource additionally includes a path up to the volume.

9. The batch processing method according to claim 6,
wherein, at the first step, whether a failure has occurred in the resource to be used by the job to be executed subsequently is determined based on whether the resource to be used by the job to be executed subsequently is a resource that was used by an abended job among the previously executed jobs in the batch processing.

10. The batch processing method according to claim 7,
wherein, at the second step, if there is a replication of the logical volume in which a failure has occurred, the job is executed by switching the logical volume to be used by the job to the replication without postponing the execution of the job.

11. A program for causing a computer to execute processing, comprising;
a first step for identifying, in batch processing using a prescribed resource, the resource to be used by a job to be executed subsequently in the batch processing and determining whether a failure has occurred in the resource; and
a second step for presenting failure information concerning the failure to a user and postponing the execution of the job until a reply is received from the user when it is determined that a failure has occurred in the resource.
